(19) United States
(12) Patent Application Publication
(10) Pub. No.: US 2013/0333236 A1
(43) Pub. Date: Dec. 19, 2013

(54) Assembly and Method for Drying Moist Material

(71) Applicant: Andre Grosser, Neumarkt (DE)

(72) Inventor: Andre Grosser, Neumarkt (DE)

(73) Assignee: HUBER SE, Berching (DE)

(21) Appl. No.: 14/001,194

(22) PCT Filed: Jan. 26, 2012
(86) PCT No.: PCT/EP2012/051180

§ 371 Date: Aug. 23, 2013

(30) Foreign Application Priority Data
Feb. 25, 2011 (DE) 10 2011 004 788.3

(51) Int. Cl. F26B 25/18

(52) U.S. Cl. CPC F26B 25/18
USPC 34/239

(57) ABSTRACT

The invention relates to a drying assembly for moist material (1), in particular sewage sludge, having a rooted drying surface (2) for accommodating the moist material (1) during the drying process thereof, and having a transport device (3) which is designed to transport the moist material (1) that is placed on the drying surface (2) in a direction of a first end face (4) of the drying surface (2). According to the invention, the drying assembly comprises a plurality of supply means (5), with the aid of which the moist material (1) can be placed onto the drying surface (2), wherein the supply means (5) are arranged such that said means are distributed between the first end face (4) and a second end face (10) of the drying surface (2), said second end face (10) being located opposite the first end face (4). The invention further relates to a method for drying moist material (1), characterized in that the moist material (1) is placed in a plurality of positions on the drying surface (2) of a drying assembly with the aid of supply means (5), wherein positions are distributed between the first end face (4) and a second end face (10) of the drying surface (2), the second end face (10) being located opposite the first end face (4).

The present invention refers to a drying assembly for moist material, especially sewage sludge, with a roofed drying surface for receiving the moist material while it dries and with a device designed for transporting the moist material that has been placed on the drying surface towards a first front side of the drying surface. Additionally, a method for drying moist material is described in which the moist material is placed on a drying assembly and transported towards a first front side of the drying surface with the help of a transportation device so it can be dried.

In order to dry moist material for further utilization such as sewage sludge, for example, it has long been state of the art to spread out moist material on a drying surface and to take out the water by means of the corresponding heating devices.

As is also known from DE 203 04 220 U1, it is furthermore customary to dry sewage sludge with the help of solar energy to lower energy costs. To accomplish this, the moist material is spread out inside a corresponding drying room that can be built similarly to a greenhouse and turned over several times by means of turnover devices. In this way, the water content of the sewage sludge can be reduced to about 10% of the initial content. In this case, the respective drying surface is laid out most of the time depending on the desired drying level, whereby as a rule, the surface is limited by the maximum transportation rate of the transportation and turnover device that has to transport the sewage sludge deposited in one front side of the assembly through the entire assembly in a given time period.

The task of this invention is therefore to suggest a drying assembly for moist material and a corresponding drying method by increasing the heating capacity compared to the state of the art without having to increase the performance of the transportation device.

The task is solved by a drying assembly and a device that have the characteristics of patent claim 1.

According to the invention, the drying assembly is characterized by having several supply means used for placing the moist material on the drying surface, whereby the supply means are distributed between the first front side and a second front side of the drying surface arranged in front of the first front side. The entry of the moist material can thus take place in several places of the assembly (which is preferably designed as a solar drier) so that the transportation device no longer has to transport the entire mass of moist material at once. Rather, only a portion of the moist material to be dried must be placed in the area of the corresponding supply means so that only this portion must be correspondingly distributed in order to ensure uniform drying. Therefore, the transportation device does not have to homogenize the moist material first and transport all of it at once, as is usually the case. Rather, a continuous process can take place in which only a portion of the moist material must always be homogenized and transported.

It is advantageous for the supply means to be arranged in a stationary way. In this case, the supply means can be connected to supply lines laid correspondingly in the assembly to ensure a continuous supply of moist material. The rigid arrangement does away with the corresponding moveable parts, resulting in an assembly that is very easy to service.

In this context, it is advantageous if at least one part of the supply means has outlets arranged in the drying surface area. The drying surface—which in this case is also preferably arranged in a stationary way—can be supplied like this with moist material directly from below, in which case the number, distribution and shape of the outlets can be freely selected.

It is especially advantageous if at least one portion of the supply means includes outlets arranged in the area of a wall contiguous to the drying surface. Such an arrangement has the advantage that the outlets are easily accessible from the outside at any time and therefore also when the assembly has been supplied. This facilitates an inspection and/or service. In this case, the outlets could also have the corresponding guiding plates that allow an especially uniform distribution of the moist material. Likewise, guiding plates placed towards the upper part can, for example, ensure that the moist material can be distributed sufficiently widely on the drying assembly after passing through the outlets.

It is advantageous if at least one portion of the supply means is arranged above the drying surface so the moist material can be placed on the drying surface and/or on already placed moist material from above. In this case, the moist material can also be transported simultaneously to the drying surface from several supply means. A time-delayed operation of individual supply means is conceivable too. Thus, it would be advantageous, for example, to operate the supply means in a way to ensure that the height of the moist material spread out is maintained at an almost constant level. To achieve this, a continuous resupply with moist material must be considered, as the height keeps dropping owing to the water loss caused by the drying process.

It is also advantageous if at least one portion of the supply means is equipped with a conveyor spiral. Conveyor spirals have proven to be very useful in transportation technology and they ensure a reliable apportioning of moist material. In addition, they can be precisely controlled so automatic operation is possible.

It is furthermore advantageous if the volume flow of the individual supply means can be individually varied with the help of a control and/or guidance unit. In this case, the drying surface does not have to be uniformly supplied with moist material to cover all of it uniformly. Rather, an adjustment of the moist material distribution is possible so that moist material can be apportioned only to selected areas of the drying surface at a certain point in time while the remaining supply means are not operating.

It is also advantageous if at least one sensor is assigned to the drying surface. With the help of this sensor, at least one parameter relevant to the drying process (e.g. the water content of the moist material or the height of the layer formed by the moist material) can be determined in a defined distance from one of the front sides. The determined values can finally be processed by a control and/or guidance unit so the individual supply means can be selectively steered based on the respective values.

It is advantageous to build the transportation device so it can satisfactorily mix or turn over the moist material. As a result of that, odor is reduced while drying capacity is enhanced because the moist material becomes more open-pored and rougher, particularly if it is sewage sludge.

Finally, the method according to the invention for drying moist material is characterized by the fact that the moist material (e.g. sewage sludge) is placed on several positions on the drying surface of a drying assembly, whereby the positions are arranged so they are distributed between a first front side and a second front side of the drying surface opposite the first front side. Usually, the entire quantity of moist material is brought into the area of one front side of the assembly with the help of a wheel loader. In this case, the transportation device used for homogenizing and further transporting the moist material to the opposite front side had to move an enormous mass of moist material (at least when the drying process started) and be correspondingly powerful for accomplishing this. This is no longer necessary thanks to the moving of the moist material done with the help of several supply means distributed across the length of the drying surface. Rather, only the portion of the moist material that is apportioned to the corresponding position must be distributed from the transport device. The transport device can be correspondingly built with less power so it consumes less energy. In this case, the quantity of moist material apportioned to the respective positions can be individually regulated. Furthermore, by implementing the invention, it is possible to deliver the moist material exclusively in an area away from one of the front sides such as the middle of the drying surface, for example. As a result of this, the moist material does not have to be transported across the entire distance between the respective front sides of the drying surface. This is particularly advantageous when solar drying equipment is used in the hot summer months because in this case a relatively short retention time is sufficient to ensure the desired drying level.

It is also advantageous for the moist material to be continuously brought into or be removed from the drying surface. In this case, the moist material spread out on the drying surface is moved in certain time intervals by a certain length towards the place of removal. After this step concludes, a new supply of moist material takes place and once again, in an advantageous further development of the invention, it is mixed directly under the already dried moist material. This can also be accomplished by the transportation device.

It is also extremely advantageous if the volume or mass of the moist material that was brought in to the respective position per unit of time depends on the distance from the corresponding position from one of the front sides. Since the water content decreases in the assembly the longer it stays there, its volume also decreases. To ensure a uniform height distribution within the assembly, it would therefore be possible to subsequently apportion the moist material continuously or in intervals.

It can likewise be advantageous if the volume or mass of the moist material brought into the corresponding position per unit of time is lower the closer it is to the corresponding position in the first front side, where the removal of the dried moist material generally takes place. As a result of this, an excessive re-moistening of the already dried moist material (caused by the subsequently apportioned moist material, which is still moist) can be prevented.

It is especially advantageous if the volume or mass of the moist material brought into the respective position per unit of time depends on the height of the moist material or water content of the moist material before, after and/or on the corresponding position or on the water content of the moist material to be brought into the drying assembly. Finally, the consideration of the respective measuring values by a control and/or guidance unit allows an automatic and individual control of the moist material supply to the corresponding positions. Thus, it is finally possible to ensure at all times optimal drying, which depends to a great extent on the height and moisture of the moist material.

It is also advantageous if the moist material is mixed—after being placed on the drying surface—with moist material that has already been placed on the drying surface. As a result of this, a homogenous product is obtained that, as far as possible, allows uniform, fast and also odorless drying. In this case, the mixing can take place with the help of the transportation device so no additional equipment is needed.

Further advantages of the invention will be described in the following embodiments, which show:

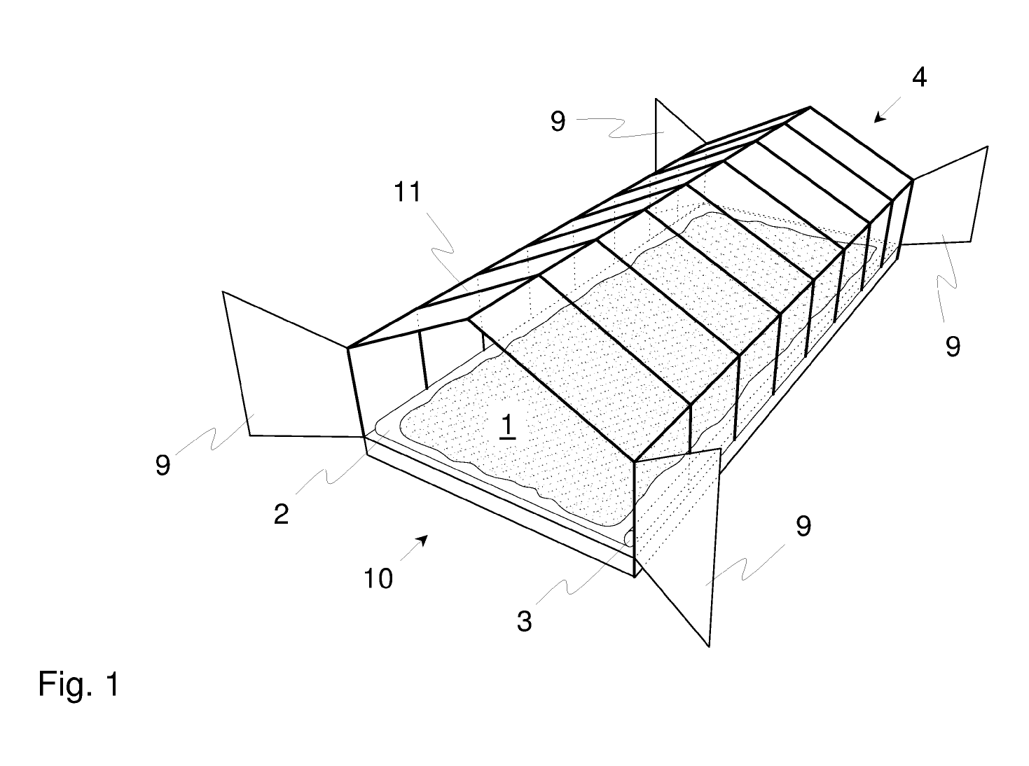

FIG. 1 A view in perspective of a drying assembly according to state of the art,

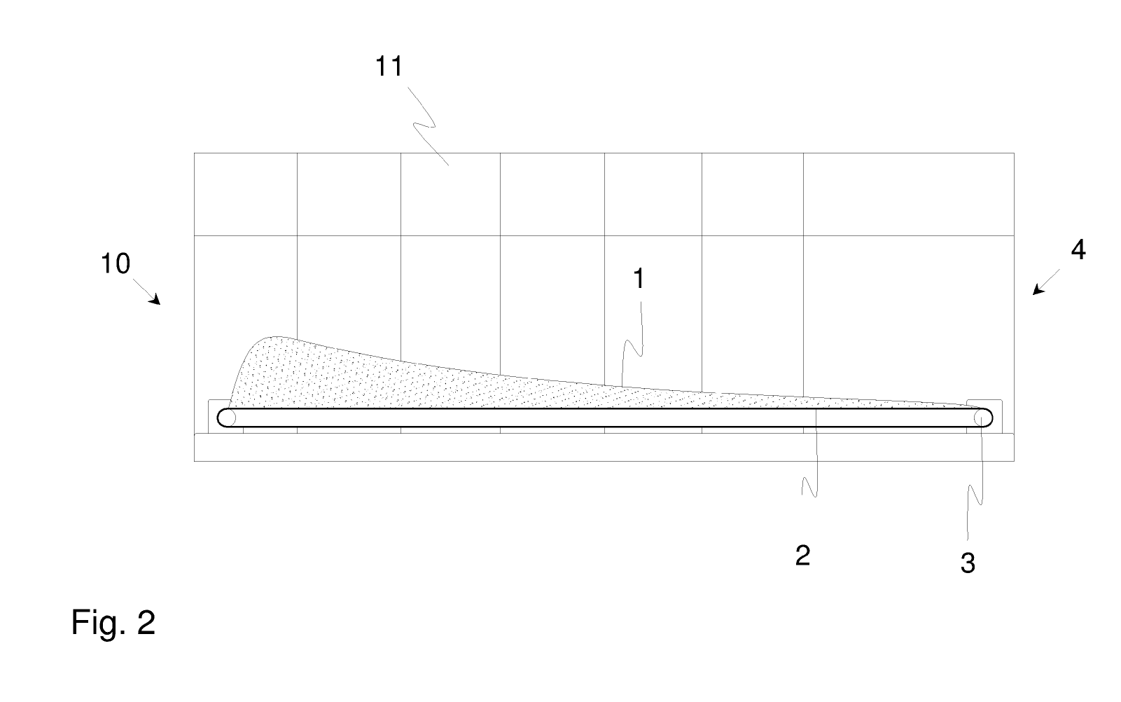

FIG. 2 A cross section of the drying assembly according to FIG. 1,

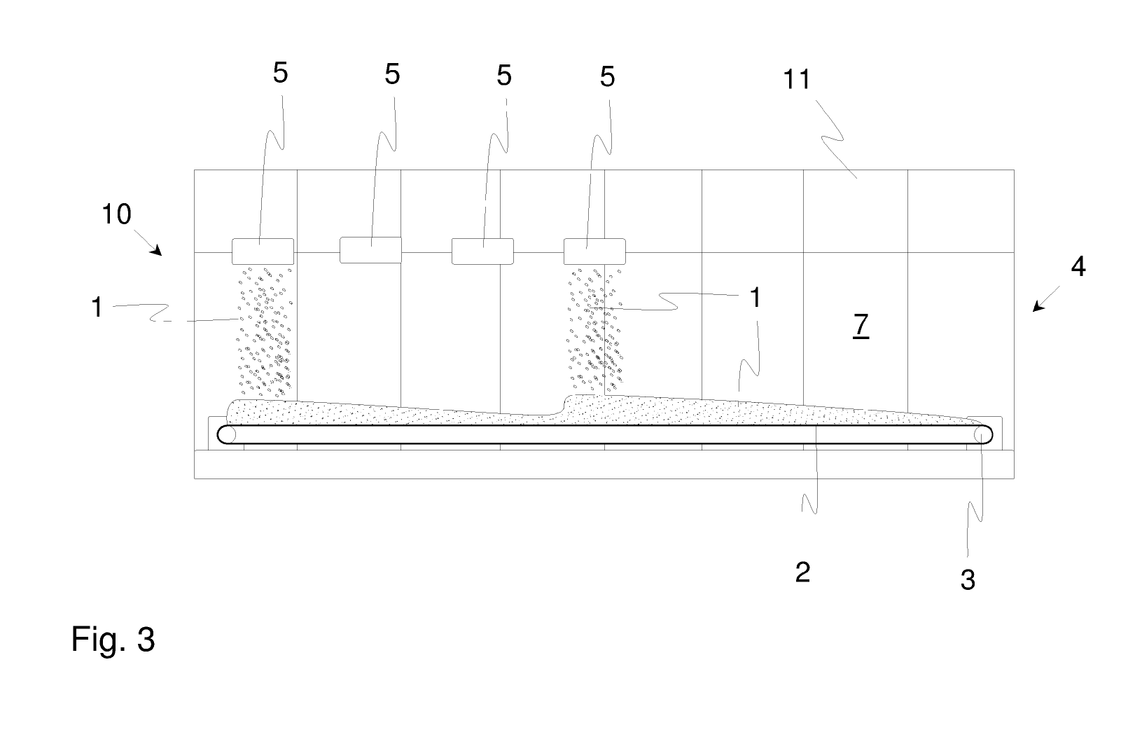

FIG. 3 A cross section of a drying assembly according to the invention,

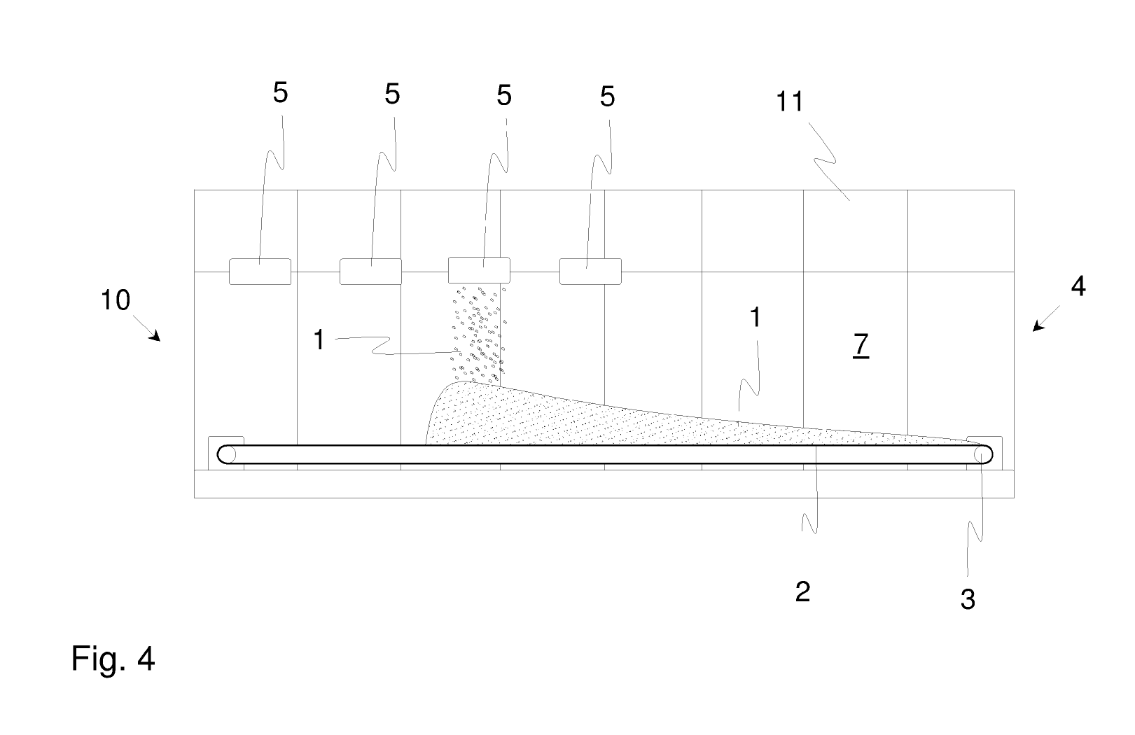

FIG. 4 Another cross section of a drying assembly according to the invention,

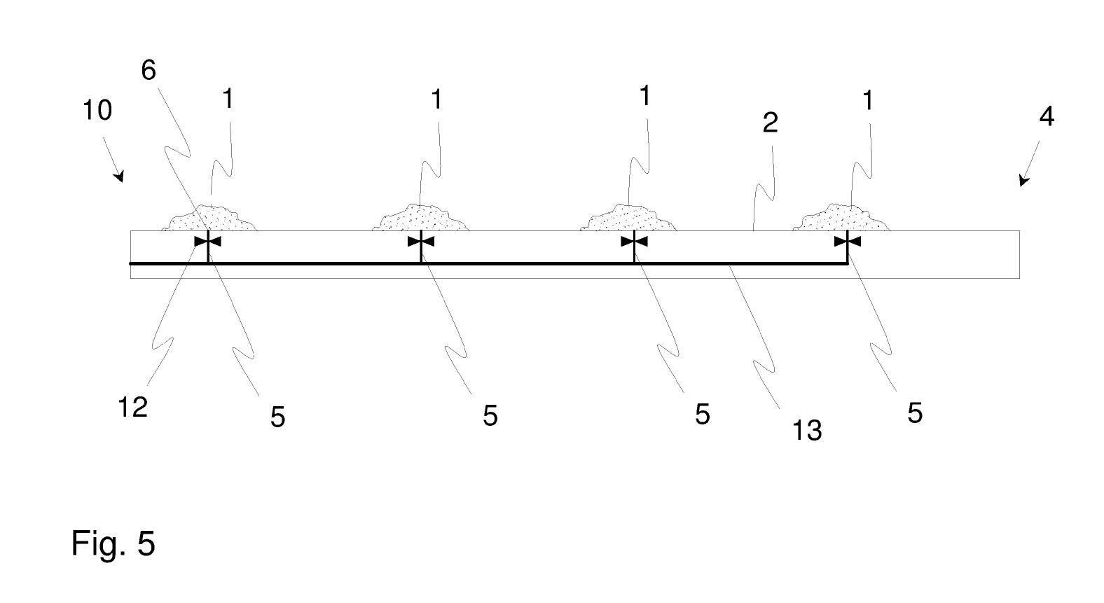

FIG. 5 A cross section of another drying assembly according to the invention,

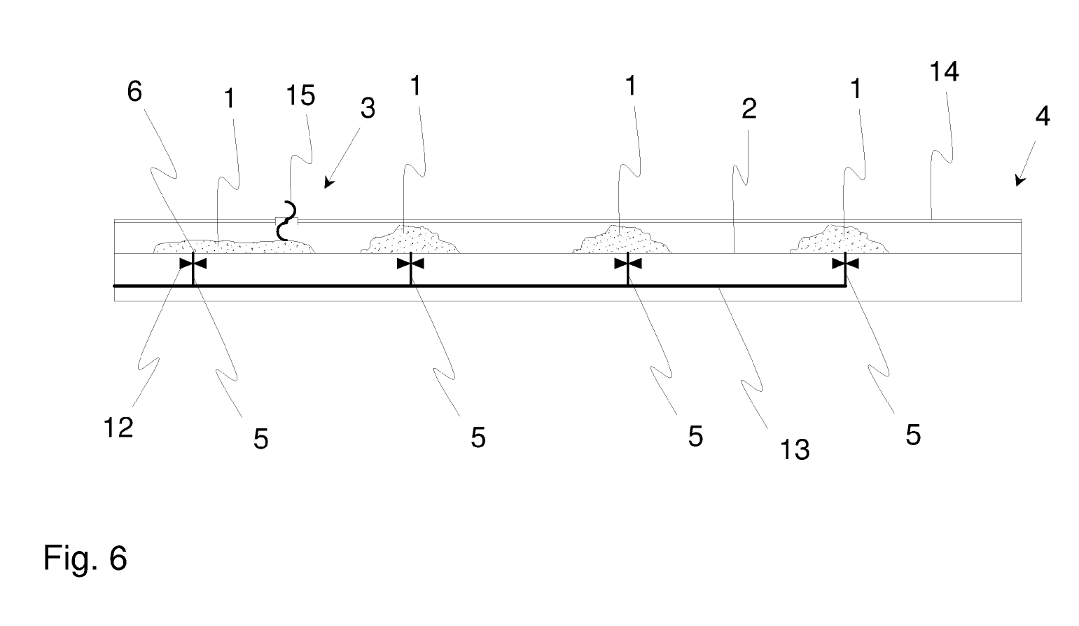

FIG. 6 Another cross section of a drying assembly according to the invention, and

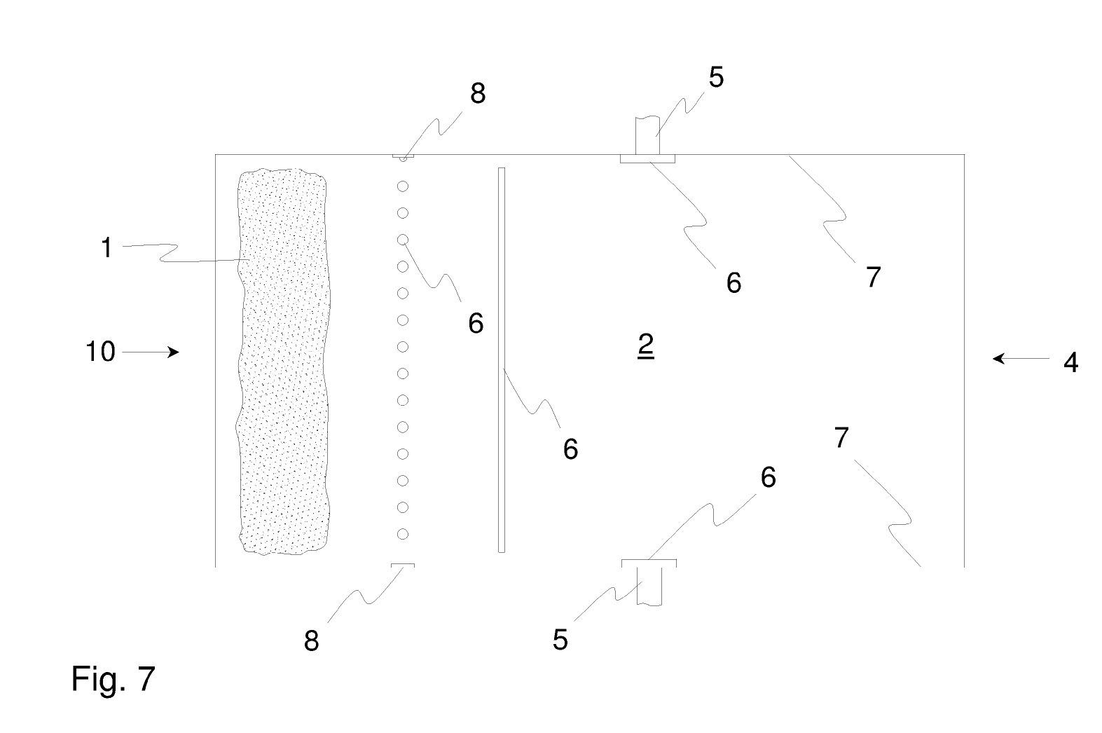

FIG. 7 A top view of a drying surface of a drying assembly according to the invention.

To begin with, it must be mentioned that in the figures showing several identical structural parts, only one of these identical parts has been identified with a reference to ensure good clarity.

FIG. 1 shows a view of a drying assembly for moist material 1 in perspective (e.g. sewage sludge) according to state of the art. The assembly is designed similarly to a greenhouse. In its bottom, it has a drying surface 2 protected by a roof 11. In order to bring the moist material 1 into the assembly and also to remove the material from it, the assembly has both in the area of a first front side 4 and in the area of an opposite second front side 10, corresponding gates 9 that can be closed if needed to ensure controlled drying.

As a rule, the drying surface 2 has a transportation device 3 for transporting the moist material 1 from the second front side 10 to the first front side 4. In the example shown, it is shaped like a conveyor belt whose surface simultaneously represents the drying surface 2. The conveyor belt, in turn, is driven by a drive (not shown) and thus accomplishes the continuous transportation of the moist material 1.

As can be seen in FIG. 2, while the moist material 1 dries on its way to the first front side 4, the water it contains starts evaporating so that the layer formed by the moist material 1 is constantly becoming lower. Drying is rather slow in the area of the second front side 10 of the assembly due to the uniform placing of the entire moist material 1 because the moisture from the interior of the layer mentioned above must reach the exterior, in which case the path that must be overcome is relatively long shortly after the moist material 1 has been placed.

Assemblies whose drying surface 2 has not been moveably executed have another disadvantage. In them, transportation is accomplished by a separate transportation device 3 like the one shown in FIG. 6. In this case, it must move the entire moist material 1 placed in the area of the second front side 4 towards the first front side 4 and this arrangement forces it to be built in correspondingly powerful way. Finally, for the area shown to the right in FIG. 2, in particular, where there is moist material 1 that is not as massive any longer, the transportation device 3 must be overly large and thus consume excessive energy (after all, the entire transportation device 3 must always be moved together with the moist material 1).

The disadvantages mentioned above can be eliminated easily by building the drying assembly, as foreseen by the invention, with several supply means 5 with whose help the moist material 1 can be placed on the drying surface 2, in which case the supply means 5 are arranged between the first front side 4 and a second front side 10 of the drying surface 2 opposite the first front side 4.

FIG. 3 shows, for example, a corresponding embodiment of a drying assembly according to the invention. As can be seen in this Figure, the placing of the moist material 1 on the drying surface 2 no longer takes place one-sidedly in the area of a front side. Rather, the assembly is equipped with several supply means 5 arranged above the drying surface 2. The respective supply means 5—which are connected preferably via the corresponding supply lines 13 (not shown) to a central moist material temporary storage—can have a spiral conveyor, for example, used for apportioning the moist material 1 so it is dropped to the drying surface 2.

In the case of FIG. 3, the first entry of the moist material 1 takes place now in the area of the second front side 10 of the drying assembly. During transportation and with the help of the transportation device 3 designed as conveyor belt, volume is reduced so that the height of the moist material gradually decreases. Once the height has reached a certain level, moist material 1 is apportioned again (in the example shown, this takes place in the center of the drying surface 2) so its height increases once again.

The corresponding maximum height, however, always turns out to be less than in assemblies built according to state of the art, as shown in FIG. 2. A more uniform—and consequently faster drying too—results from this in the end. In addition, it is naturally possible to mix the moist material 1 brought into and placed on the second position with the help of a corresponding turning device with the already partially dried moist material 1 placed in the first position (arranged to the left in FIG. 3) on the drying surface 2. In the end, this leads to less generation of odor and higher evaporation because the moist material 1 becomes more open pored and rougher, especially if it is sewage sludge.

Needless to say, as an alternative to the conveyor belt shown, a transportation device 3 can also be used in this case when the drying surface 2 is stationary, as shown exemplarily in FIG. 6 (by the way, this also applies to the assembly shown in FIG. 4).

It should also be pointed out that FIG. 3 shows four supply means 5 separated from one another and arranged on four positions of the drying assembly. Naturally, their number can be freely chosen and adapted to actual conditions. It is likewise also possible to arrange several supply means 5 in a direction perpendicular to the drawing plane in order to accomplish the most uniform entry possible of the moist material 1. Likewise, all supply means 5 can be operated simultaneously or fully or partially independently from one another.

FIG. 4 shows another option for supplying the assembly. This option considers the fact that more heat enters the assembly from the outside in the hot months. For this reason, the overall drying performance of the drying assembly preferably built as solar dryer is therefore higher than in the cold winter months. So the moist material 1 is not overly dried when the hauling speed of the drying device remains the same during the summer months, the moist material 1 can, if necessary, be brought in exclusively to a position in an area spaced away from the second front side 10 of the drying surface 2. Thus, the entry in FIG. 4 takes place merely in the third position from the left, which is relatively far away from the second front side 10. As a result of that, the moist material 1 does not stay as long inside the assembly, preventing it from drying excessively.

FIG. 5 shows a cross section of another drying assembly according to the invention (but the roof 11 is not shown). In this case, the supply means 5 comprise several outlets 6 that allow the moist material 1 to come out to the corresponding final areas of a supply line 13 and on the drying surface 2 arranged above it in a stationary position. So the volume or mass flow of the moist material 1 can be individually regulated, valves 12 (whose position can be preferably regulated by means of a control unit) have been allocated to the respective outlets 6.

The corresponding transportation of the moist material 1 also takes place in this case with the help of a transportation device 3 like the one shown in FIG. 6, for example. It has a turning axis with two opposing wings 15 running, if possible, perpendicularly to the turning axis. Additionally, the axis (which can be moved to rotate with the help of a controllable drive) can be displaced on guiding rails 14 mounted on both sides of the drying surface 2 so the moist material 1 can be distributed along the drying surface 2 via the outlets 6 that lead to the drying surface 2.

Furthermore, the turning axis is preferably movably arranged in vertical direction too so it is able not just to homogenize the moist material 1, as shown on the left side of FIG. 6. Rather the vertical placement allows the moist material 1 to be completely transported and mixed; in this case, the wings 15 should preferably reach all the way to the drying surface 2.

Finally, possible outlets 6 both in the area of the drying surface 2 and in the corresponding lateral walls 7 are shown in FIG. 7. Here, the shapes and respective arrangements of the outlets 6 must be merely regarded as examples. In the final analysis, the outlets 6 can be distributed in any form, number and opposite arrangement with respect to one another above the assembly.

Finally, FIG. 7 shows a possible arrangement of a sensor 8 that detects, for example, the height of the moist material 1 coming out of the outlets 6. Finally, the volume and mass flow of the moist material 1 can be controlled based on the values determined or the use of the transportation device 3 as well.

Apart from that, the invention is not limited to the embodiments shown. Rather, all combinations of the described individual characteristics in the way they are shown or described in the claims, description and figures are the object of the invention as far as a corresponding combination is technically possible or seems meaningful.

### LIST OF REFERENCES

1 Moist material
2 Drying surface
3 Transportation device
4 First front side
5 Supply means
6 Outlets
7 Wall
8 Sensor
9 Gate
10 Second front side
11 Roof
12 Valve
13 Supply line
14 Guiding rail
15 Wing

1. Drying assembly for moist material (1), especially sewage sludge, with a roofed drying surface (2) for receiving the moist material (1) while it dries and with a transportation device (3) developed for transporting the moist material (1) placed on the drying surface (2) towards a first front side (4) of the drying surface (2) characterized in that the drying assembly has several supply means (5) with whose help the moist material (1) can be placed on the drying surface (2), whereby the supply means (5) are arranged between the first front side (4) and a second front side (10) opposite the first front side (4) of the drying surface (2).

2-15. (canceled)
